(19) United States
(12) Patent Application Publication
(10) Pub. No.: US 2008/0104850 A1
(43) Pub. Date: May 8, 2008

(54) Edge trimmer for elastomer strip

(75) Inventors: Gaku Tanaka, Kobe-shi (JP); Kazuaki Yarimizu, Kobe-shi (JP)

Correspondence Address: BIRCH STEWART KOLASCH & BIRCH, PO BOX 747, FALLS CHURCH, VA, 22040-0747, US

(73) Assignee: Sumitomo Rubber Industries, Ltd.

(21) Appl. No.: 11/905,941

(22) Filed: Oct. 5, 2007

(30) Foreign Application Priority Data
Nov. 7, 2006 (JP) 2006-301878

(51) Int. Cl. B26B 17/00

(52) U.S. Cl. 30/173; 30/351

(57) ABSTRACT

An edge trimmer for an uncured elastomer strip being conveyed in the longitudinal direction of the strip is disclosed. In the uncured elastomer strip, cords laid parallel with each other along the longitudinal direction of the strip, are embedded. The edge trimmer comprises a cutter head comprising a blade for trimming an edge portion of the uncured elastomer strip. The cutter head is freely movable in the transverse direction of the uncured elastomer strip being conveyed. The blade has a pair of v-shaped cutting edges opening towards the upper stream of the conveyed direction of the uncured elastomer strip. Preferably, the thickness of the blade is 1.0 to 2.0 mm, the opening angle of the V-shaped cutting edges is 30 to 70 degrees, an angle of each of the cutting edges is 35 to 65 degrees, and the cutting edges are formed on the thickness center plane of the blade.

### BACKGROUND OF THE INVENTION

The present invention relates to an edge trimmer for an uncured elastomer strip such as rubberized tire cord fabrics, more particularly to a structure of a cutter head capable of trimming away the edge portion, leaving a minimum margin.

In general, pneumatic tires are provided with various reinforcing cord layers, e.g. a carcass, tread reinforcing belts, bead reinforcing layers and the like. During manufacturing a green tire, such reinforcing cord layers are assembled together with other tire components in their unvulcanized states.

The unvulcanized reinforcing cord layers are formed as follows: As shown in FIGS. 8 and 9, a rubberized tire cord fabric (c) in which cords (a) are embedded in parallel with the longitudinal direction thereof is cut at an angle (beta) and a width (w). Then, the edges (d1) of the cut pieces (d) are butt jointed or overlap jointed to thereby form a strip in which cords are laid in parallel with each other at the angle (beta) with respect to the longitudinal direction of the strip. For example, in the case of a radial carcass ply, the angle (beta) of the cords in the strip is 90 degrees. In the case of the breaker ply, the angle (beta) is about 10 to 40 degrees.

On the other hand, when the rubberized tire cord fabric (c) is formed by calendering or the like, usually, as shown in FIG. 10, an irregular edge portion (e) where no cord is embedded is formed along the edges of the tire cord fabric (c). Therefore, it is necessary to cut off the edge portion, while leaving a minimum margin (jg) for the purpose of jointing.

Heretofore, in order to cut off the unnecessary edge portion, a fixed emery wheel was used. The use of the fixed emery wheel is not problematic when the tire cords (a) can be laid in good order like in the usual straight steel cords. But, in the case of organic fiber cords, as the cords are relatively flexible, even if the cords are initially laid in good order, the cords are liable to be disordered due to the existence of wefts (f), dipping treatments applied to the cord fabric and the like. As a result, the outermost tire cord (a1) largely undulates in the widthwise direction as exaggeratedly shown in FIG. 11.

Accordingly, there is a possibility that the outermost tire cord (a1) is damaged by the emery wheel, and the outermost tire cord (a1) is exposed or protrudes from the cut edge which means that the minimum margin (jg) can not be secured. Therefore, the joint strength and durability, and the cord strength and durability are liable to reduce. Such problems may further induce a deterioration of tire uniformity, defects in appearance such as bulge and dent on the surface of the vulcanized tire, and the like.

### SUMMARY OF THE INVENTION

It is therefore, an object of the present invention to provide an edge trimmer, by which the edge portion of the uncured elastomer strip can be trimmed away, without damaging the embedded cords.

According to the present invention, an edge trimmer comprises

a cutter head comprising a blade for trimming an edge portion of the uncured elastomer strip, wherein

the cutter head is supported freely movable in the transverse direction of the uncured elastomer strip being conveyed, and

the blade has a pair of V-shaped cutting edges opening towards the upper stream of the conveyed direction of the uncured elastomer strip.

Preferably, the blade has a thickness of 1.0 to 2.0 mm. The v-shaped cutting edges have an opening angle (theta) of from 30 to 70 degrees and an edge angle (alpha) of from 35 to 65 degrees. The cutting edges are formed on the thickness center plane of the blade.

### BRIEF DESCRIPTION OF THE DRAWINGS

FIG. 1 is a diagrammatic side view for explaining an edge trimmer according to the present invention.

FIG. 2 is a perspective view of the uncured elastomer strip and a main part of the edge trimmer at the time of trimming.

FIG. 3 is a partial front view of the edge trimmer viewed from the upstream of the conveying direction of the uncured elastomer strip.

FIG. 4 is an exploded perspective view of the cutter head.

FIG. 5 is a cross sectional view of the cutter head.

FIG. 6 is a side view of the blade.

FIG. 7 is a front view of the blade.

FIG. 8 is a plan view of the uncured elastomer strip cut into a plurality of pieces.

FIG. 9 is a plan view of a strip for forming a reinforcing cord layer of a tire which strip is formed by jointing the edges of the cut pieces.

FIG. 10 is an enlarged cross sectional view of the edge portion of the uncured elastomer strip.

FIG. 11 is a plan view of the uncured elastomer strip showing the disordered embedded cords in an exaggerated form.

### DESCRIPTION OF THE PREFERRED EMBODIMENT(S)

An embodiment of the present invention will now be described in detail in conjunction with accompanying drawings.

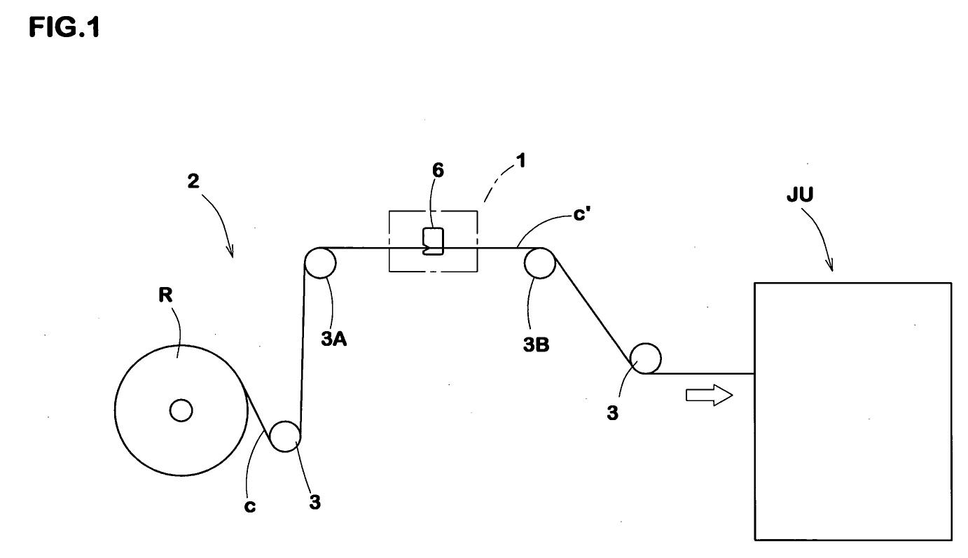

In this embodiment, edge trimmer 1 according to the present invention is incorporated in a feed unit 2 for feeding a cutting-and-jointing unit JU with an uncured elastomer strip (c) as schematically shown in FIG. 1.

The feed unit 2 comprises:

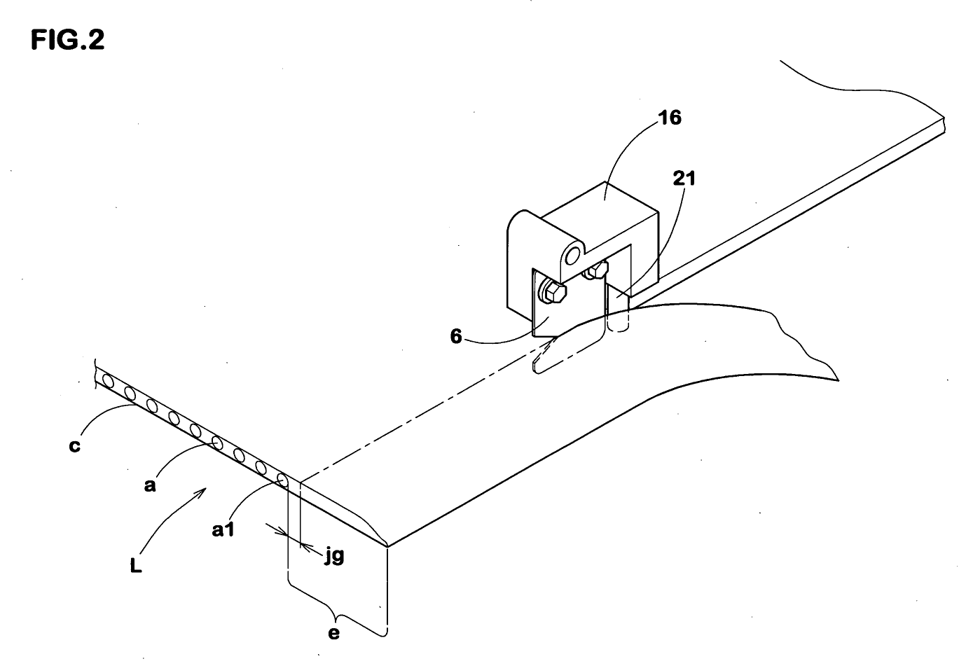

a roll R of an uncured elastomer strip (c);
a conveyer 3 receiving the strip (c) supplied from the roll R and including conveyor rollers 3A and 3B; and
the edge trimmer 1 disposed between the conveyor rollers 3A and 3B, so that the edge portions (e) of the uncured elastomer strip (c) is trimmed away during the strip (c) is being conveyed as shown in FIG. 2.

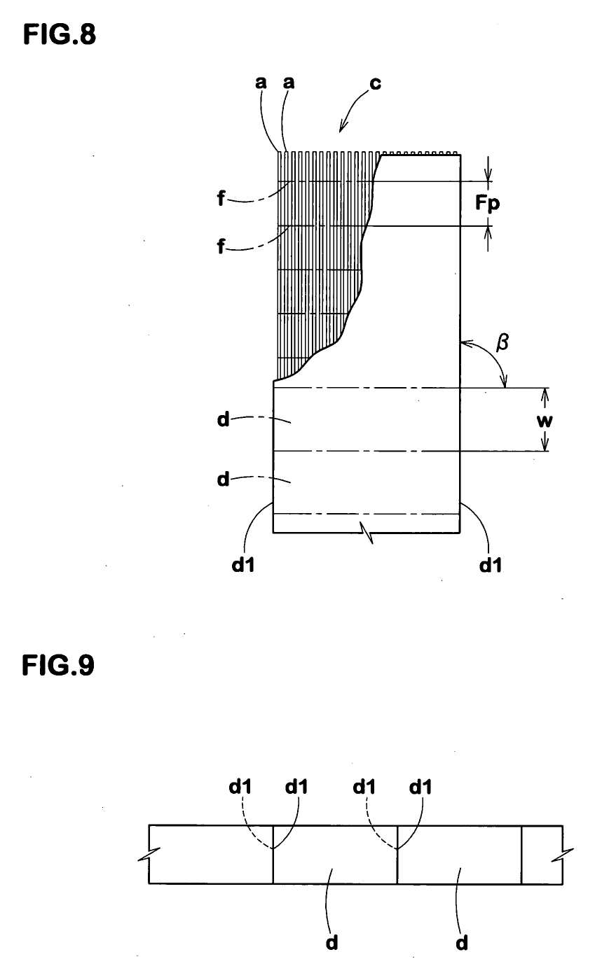

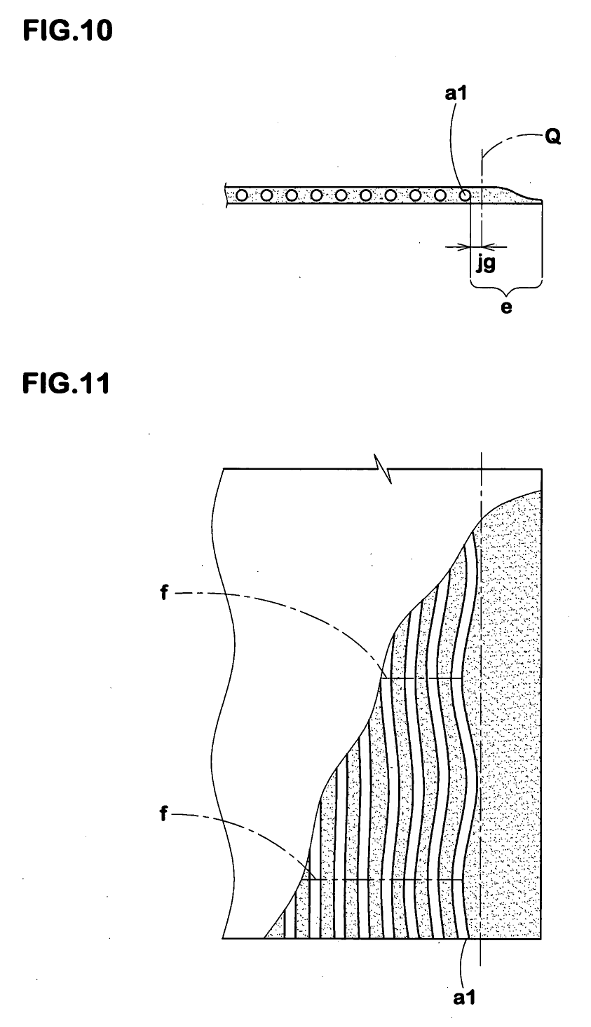

The uncured elastomer strip (c) is a rubberized tire cord fabric in which, as shown in FIG. 8, a large number of warps (a) which are organic fiber cords and a small number of wefts (f) which are thin organic fiber cords are interwoven. As shown in FIG. 2, the rubberized tire cord fabric (c) has, on the outside of each of the outermost tire cords (a1), an edge portion (e) made up of the topping rubber only (namely, there is no cord). The edge portion (e) is cut off at a position of a positive distance (jg) from the outermost tire cord (a1) so as to secure a minimum margin which serves as a splice/overlap joint or butt joint. For example. the uncured elastomer strip has a thickness of 1.0 mm and a width of 500 mm, and the length is 300 m per roll R. The warps (a) are high modulus polyester fiber cords of 1670 dtex/2 (cord diameter 0.68 mm) and the cord count is 50 ends/5 cm width.

The trimmed uncured elastomer strip (c′) is conveyed to the above-mentioned cutting-and-jointing unit JU in which the strip (c′) is cut at an angle (beta) and a width (w) as shown in FIG. 8, and then, as shown in FIG. 9, the edges (dl) of the cut pieces (d) are jointed so as to form a strip in which the cords are laid in parallel with each other at the angle (beta) with respect to the longitudinal direction of the strip.

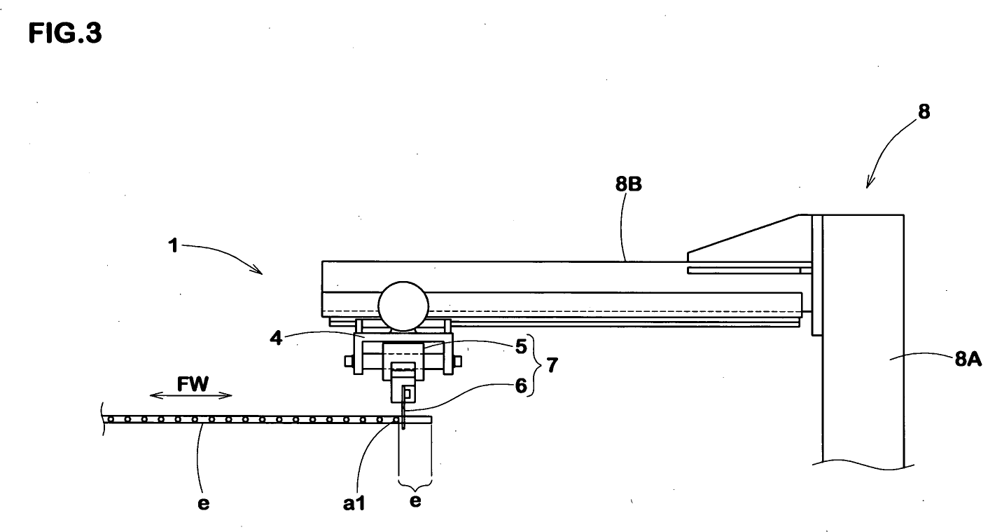

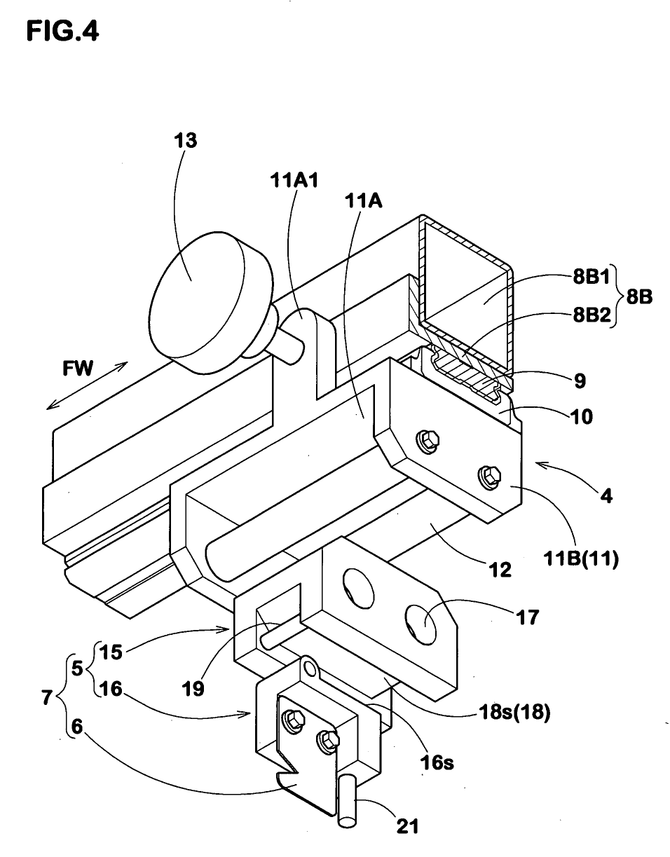

AS shown in FIG. 3, the edge trimmer 1 comprises:

a main frame 8;
a sub frame 4 supported by the main frame 8 so as to vary and fix its position in the traverse direction FW; and
a cutter head 7 comprising a self-aligning blade holder 5 disposed on the sub frame 4 slidably in the traverse direction FW. Here, the “traverse direction FW” means that of the lane L in which the uncured elastomer strip (c) is conveyed. During the strip (c) is conveyed, the warps (a) become parallel with the conveying direction. The “traverse direction FW” is thus parallel with the widthwise direction of the conveyed strip (c) which is orthogonal to the longitudinal direction FL of the strip (c).

The main frame 8 comprises:

a supporting post (or wall) 8A standing on each side of the lane L or the conveyed elastomer strip (c); and
a lateral frame 8B one end of which is fixed to the supporting post 8A and which extends in the traverse direction FW passing over the lane L or the conveyed elastomer strip (c).
The lateral frame 8B is provided with a guide rail 9 so as to extend in parallel with the traverse direction FW. The guide rail 9 is fixed onto the under surface of the main portion 8B1 of the lateral frame 8B through a stabilizing member 8B2 having a L-shaped cross-sectional shape. The main portion 8B1 has a rectangular cross-sectional shape.

The sub frame 4 comprises: a carrier 11 provided on its upper surface with a bearing 10 engaging with the above-mentioned guide rail 9, thereby the carrier 11 is guided and supported slidably in the traverse direction Fw. The carrier 11 in this example comprises: a main plate 11A provided with the above-mentioned bearing 10; and a pair of side plates 11B extending downward one from each side of the main plate 11A so as to have a generally reversed U-shape. In order to fix the carrier 11 immovably in relation to the lateral frame 8B, the sub frame 4 provided with a fixing device 13. The fixing device 13 in this example is a setscrew provided at one end with a knob to be rotatable by a hand, and the other end is screwed into a threaded through hole formed on an upright part 11A1 standing from the main plate 11A. By rotating the knob one direction, the other end is pressed against the side face of the lateral frame 8B and thereby the carrier 11 can be fixed at any position. By rotating the knob the other direction, the carrier 11 can be released.

Between the side plates 11B, there are disposed a pair of parallel guide shafts 12 extending in the traverse direction FW to support the cutter head 7.

The cutter head 7 comprises a blade 6 and the self-aligning blade holder 5.

The blade holder 5 comprises a slidable frame 15 and a tiltable frame 16.

The slidable frame 15 is guided and supported by the above-mentioned guide shafts 12 and the slidable frame 15 is freely movable in the traverse direction FW within a predetermined range, by the forces received by the blade 6 and the undermentioned optional round bar 21 from the strip (c) during trimming. In this example, the slidable frame 15 is a block which is provided with a pair of guide holes 17 extending therethrough. The guide holes 17 are provided therein with bearings and the guide shafts 12 pass slidably therethrough. Further, the block is provided in the under surface with a groove-like portion 18 for mounting the tiltable frame 16, extending in the longitudinal direction FL or the conveying direction of the strip (c). The width of the slidable frame 15 is smaller than the width between the above-mentioned side plates 10B, therefore, the slidable frame 15 can slide freely by the amount corresponding to the difference between these widths, and this amount must be larger than the expected maximum amount of the undulation of the outermost tire cord (a1) in the widthwise direction, but at most 50 mm will be sufficient.

Between the sidewall faces of the groove-like portion 18, there is provided with a shaft 19 extending in parallel with the traverse direction FW to support the tiltable frame 16.

The tiltable frame 16 is a block provided on the upper surface 16s with a protrusion protruding at the end on the upper stream side, and the protrusion is provided with a hole through which the shaft 19 is inserted, thereby the tiltable frame 16 is supported by the shaft 19 and can tilt around the shaft.

The blade 6 is attached to a recessed portion of the tiltable frame 16 so that the blade 6 becomes parallel to the conveying direction of the strip (c).

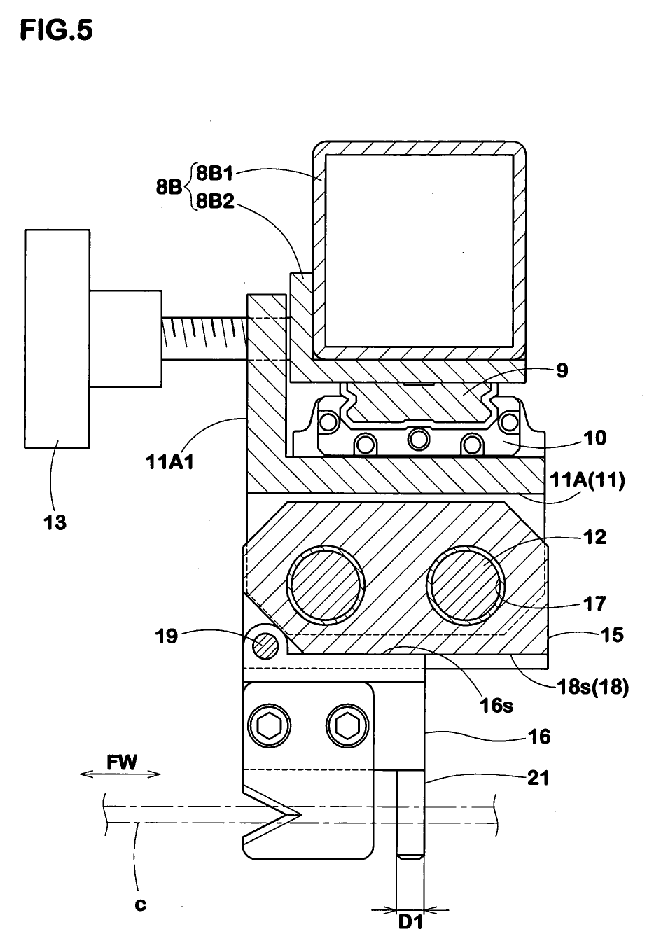

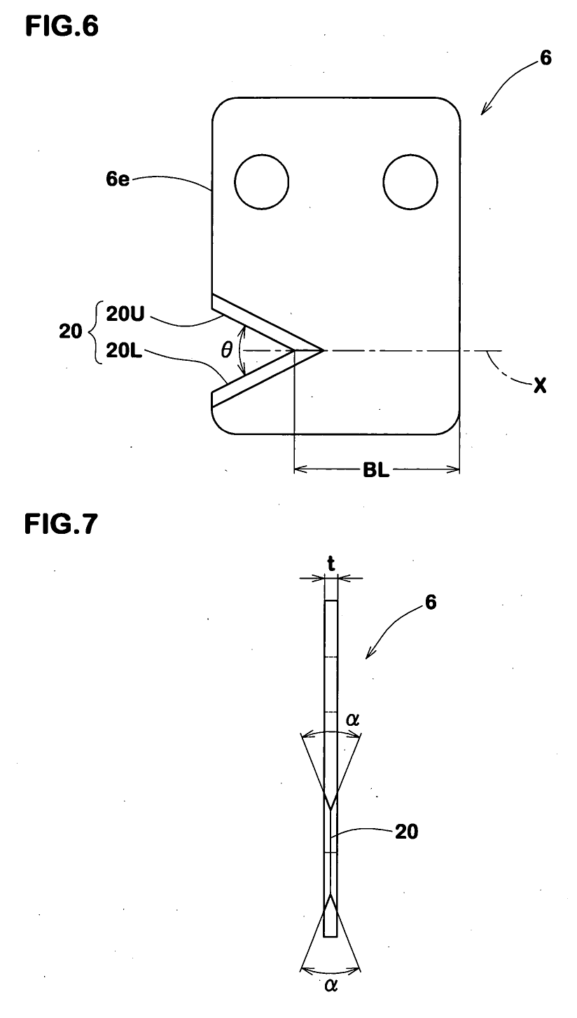

The blade 6 has a thickness (t) of 1.0 to 2.0 mm, and as shown in FIG. 6, the front edge 6e to be placed on the upstream side is provided with cutting edges 20 in a V-shaped formation opened towards the upstream of the conveying direction. The opening angle (theta) between the upper cutting edge 20u and lower cutting edge 20L is not less than 30 degrees, preferably not less than 40 degrees, but not more than 70 degrees, preferably not more than 60 degrees. The length of the upper cutting edge 20u is the same as the length of the lower cutting edge 20L. In use, a straight line X dividing the opening angle (theta) into two equal parts becomes parallel with the uncured elastomer strip (c) and positioned at the thickness center of the strip (c). The length BL of the blade 6 measured along the straight line X from the vertex of the v-shape of the cutting edges 20 to the rear edge is at least 10 mm, preferably at least 15 mm. If there are wefts (f), it is preferable than the length BL is less than ¼ times the interval Fp of the wefts (f).

As shown in FIG. 7, in a plane perpendicular to the above-mentioned line X, the angle (alpha) of the cutting edges 20u and 20L is not less than 35 degrees, preferably not less than 40 degrees, but not more than 65 degrees, preferably not more than 60 degrees (these values are very large when compared with the angles of general-use knives), and the cutting edge is formed on the thickness center plane of the blade 6.

The above-mentioned tiltable frame 16 is further provided on the downstream side of the blade 6 with a round bar 21. Preferably, the round bar 21 is a roller rotatable around its central axis. The central axis is placed on the thickness central plane of the blade 6. The round bar 21 extends near to the lower edge of the blade 6 across the above-mentioned straight line X. The diameter D1 of the round bar 21 is set in a range of from 2.0 to 5.0 times the thickness (t) of the blade 6. Accordingly, the round bar 21 protrudes from each of the side surfaces of the blade 6 by (0.5 to 2.0)t. The position of the round bar 21 is preferably immediately behind the blade 6, and the space between the rear edge of the blade and the round bar 21 is almost same as the diameter D1.

When the upper surface 16s of the tiltable frame 16 contacts with the bottom face 18s of the groove-like portion 18, the straight line X lays substantially in the horizontal direction and becomes parallel with the uncured elastomer strip (c).

During trimming the edge portion, the cutter head 7 which is free to move tends to move towards the widthwise center of the conveyed strip (c). In other words, the blade receives such a forced from the strip during trimming. when the cutter head 7 moves and the blade 6 approaches the outermost tire cord (a1), as the round bar 21 more approaches the outermost tire cord (a1), the round bar 21 receives a reactive force therefrom, and the resistance to the approaching motion increases. Thus, the blade 6 is kept at a proper distance from the outermost tire cord (a1). Therefore, even if the outermost tire cord (a1) is undulated, the edge portion can be trimmed away, leaving a proper margin (jg), without damaging the cord. Even if the round bar 21 is not provided, due to the structures of the blade 6 and blade holder 5, the edge portion can be trimmed away, leaving a minimum margin, without damaging the cord. However, as the round bar 21 helps to prevent the uncured elastomer of the cut edges from adhering to the blade 6 and thus prevent the blade 6 from becoming blunt, it is preferable to provide the round bar 21.

If the blade 6 does not have the above-mentioned v-shaped cutting edges 20, for example, if the blade 6 has a straight cutting edge, then the cutter head 7 tends to move towards irregular directions rather than towards the widthwise center of the conveyed strip (c).

If the thickness (t) of the blade 6 is less than 1.0 mm, the blade 6 is too thin for the cord thickness, more specifically, too thin for the roughness of the cord surface. As a result, the blade 6 tends to bite into the rough surface of the cord even though the edge angle (alpha) is very large. Thus, the cord is liable to be damaged. If the thickness (t) is more than 2.0 mm, the margin (jg) tends to have a larger variation, and the margin (jg) tends to shift toward larger values.

If the opening angle (theta) of the cutting edges 20 is less than 30 degrees, there is a possibility that the cord is trapped between the cutting edges 20 and the cord is pulled off or cut finally. If the opening angle (theta) is more than 70 degrees, as the edge angle (alpha) is very large, the edge portion is plucked away rather than cut away, and the variation of the margin (jg) becomes very large, and there is a possibility that the outermost tire cord (a1) becomes exposed, namely, the margin (jg) becomes zero.

If the edge angle (alpha) of the blade is less than 35 degrees, there is a high possibility that the outermost tire cord (a1) is cut. If the edge angle (alpha) is more than 65 degrees, the edge portion is plucked away rather than cut away, and the above-mentioned problems arise.

The above-mentioned minimum margin (jg) is preferably in a range of from 0.25 to 0.75 times the space D between the cords (A). such preferable minimum margin (jg) can be obtained by the above structure. The minimum margin (jg) can be adjusted by changing the diameter D1 of the round bar 21, the thickness (t) of the blade 6 and the edge angle (alpha). By increasing these values, the margin will be increased.

1. An edge trimmer for an uncured elastomer strip being conveyed in the longitudinal direction of the strip,
said uncured elastomer strip (c) including cords (a) embedded therein so that the cords (a) are laid parallel with each other along the longitudinal direction of the strip,
the edge trimmer (1) comprising:
a cutter head (7) comprising a blade (6) for trimming an edge portion (e) of the uncured elastomer strip (c);
said cutter head (7) freely movable in the transverse direction of the uncured elastomer strip (c) being conveyed; and
the blade (6) having a pair of V-shaped cutting edges (20) opening towards the upper stream of the conveyed direction of the uncured elastomer strip (c).

2. The edge trimmer according to claim 1, wherein
the blade (6) has a thickness (t) of 1.0 to 2.0 mm, and
the v-shaped cutting edges (20) have an opening angle (theta) of from 30 to 70 degrees, and an edge angle (alpha) of from 35 to 65 degrees.

3. The edge trimmer according to claim 2, wherein
the cutting edge (20) of the blade (6) is formed on the thickness center plane of the blade.

4. The edge trimmer according to claim 2, wherein
said cutter head (7) comprising a round bar (21) positioned on the downstream side of the blade (6) so that the central axis of the round bar (21) is aligned with the thickness center of the blade (6) and the round bar (21) extends across a center line (x) passing through the vertex of the V-shape of the cutting edges (20), and
the round bar (21) has a diameter (D1) in a range of from 2.0 to 5.0 times the thickness (t) of the blade (6).

5. The edge trimmer according to claim 1, wherein
said cords (a) are organic fiber cords.

6. The edge trimmer according to claim 1, wherein
said uncured elastomer strip (c) further includes organic fiber cords (f) in addition to said cords (a), and said cords (a) and said organic fiber cords (f) are interwoven as a larger number of warps and a small number of wefts, respectively.
